(19) United States
(12) Patent Application Publication
(10) Pub. No.: US 2022/0070697 A1
(43) Pub. Date: Mar. 3, 2022

(54) Methods, Apparatus and Machine-Readable Mediums Relating to Power Failure Notifications in a Communication Network

(71) Applicant: Telefonaktiebolaget LM Ericsson (publ), Stockholm (SE)

(72) Inventors: Lackis Eleftheriadis, Gävle (SE); Athanasios Karapantelakis, Solna (SE); Maxim Teslenko, Sollentuna (SE); Leonid Mokrushin, Uppsala (SE)

(21) Appl. No.: 17/414,453

(22) PCT Filed: Dec. 21, 2018
(86) PCT No.: PCT/EP2018/086672

§ 371 Date: Jun. 16, 2021

(51) Int. Cl. H04W 24/04; G06F 1/30; H04W 24/02; H04W 52/36; H04L 12/24

(52) U.S. Cl. CPC H04W 24/04; G06F 1/30; H04L 41/06; H04W 52/365; H04W 24/02

(57) ABSTRACT

The present disclosure provides methods, apparatus and machine-readable mediums relating to power failure notifications in a communication network. One method performed by a network node comprises, in response to a determination that a power supply unit in a base station has failed, comparing an available power of one or more remaining operational power supply units in the base station with a predicted power usage of the base station to determine a power headroom. The method further comprises determining whether to generate an alert signal based on the power headroom.

### TECHNICAL FIELD

Embodiments of the present disclosure relate to communication networks, and particularly to methods, apparatus and machine-readable mediums relating to power failure notifications in a communication network.

### BACKGROUND

In a typical wireless communication network, base stations provide wireless devices with access to the rest of the network. Each base station in the network is supplied with power by one or more power supply units. However, the power supply units in a base station have a finite lifetime, and a power supply unit failure can lead to a power outage at the base station. This, in turn, can cause the base station to suspend its operation, leading to a loss of service or limited service provision for wireless devices in cells served by the base station.

Wireless communication networks are often provided with a Network Operations Centre (NOC) for scheduling the repair and replacement of various components of the network, including faulty power supplies. When a power supply fails in a base station, the base station transmits an alarm to an Operations Support System, and the alarm is then processed and handled at the NOC. Operators at the NOC may schedule repair or replacement of the faulty power supply unit.

One problem with this arrangement is that base stations are often provided with multiple power supplies and a wireless communication network will generally include a large number of base stations. As a result, power supply failures can be a relatively frequent occurrence in wireless communication networks, which means that NOCs receive large numbers of alarms relating to power supply failures. This can incur a considerable signalling overhead, as the alarms are transmitted from the base station to the NOC. It can also place pressure on operations at the NOC, as the repair and replacement of large numbers of failed power supplies must be scheduled with only finite resources.

### SUMMARY

Embodiments of the present disclosure seek to address these and other problems.

In one aspect, the present disclosure provides a method performed by a network node in a wireless communication network. The method comprises, responsive to a determination that a power supply unit in a base station in the wireless communication network has failed, comparing an available power of one or more remaining operational power supply units in the base station with a predicted power usage of the base station to determine a power headroom; and determining whether to generate an alert signal based on the power headroom.

Apparatus and machine-readable mediums are also provided for performing the method set out above. For example, in one aspect there is provided a network node in a wireless communication network. The network node comprises processing circuitry and a machine-readable medium storing instructions which, when executed by the processing circuitry, cause the network node to: responsive to a determination that a power supply unit in a base station in the wireless communication network has failed, compare an available power of one or more remaining operational power supply units in the base station with a predicted power usage of the base station to determine a power headroom. The network node is further caused to determine whether to generate an alert signal based on the power headroom.

### BRIEF DESCRIPTION OF THE DRAWINGS

For a better understanding of examples of the present disclosure, and to show more clearly how the examples may be carried into effect, reference will now be made, by way of example only, to the following drawings in which:

FIG. 1 is a schematic illustration of a wireless communication network according to embodiments of the disclosure;

FIG. 2 is a schematic illustration of a network node according to embodiments of the disclosure;

FIG. 3 is an illustration of a variation in the power usage and available power at a base station over time;

FIG. 4 is a flowchart of a method performed by a network node according to embodiments of the disclosure; and

FIGS. 5 and 6 illustrate a network node according to embodiments of the disclosure.

### DETAILED DESCRIPTION

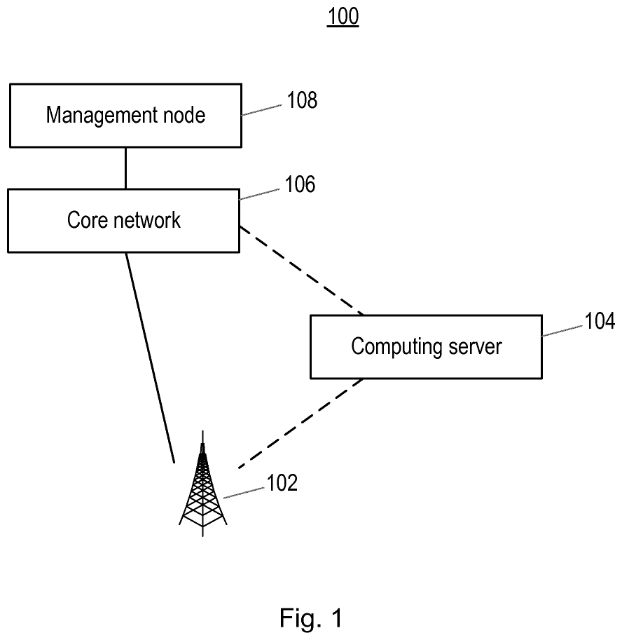

FIG. 1 shows a wireless communication network 100 according to embodiments of the present disclosure. The network 100 may implement any suitable wireless communications protocol or technology, such as Global System for Mobile communication (GSM), Wide Code-Division Multiple Access (WCDMA), Long Term Evolution (LTE), New Radio (NR), WiFi, WiMAX, or Bluetooth wireless technologies. In one particular example, the network 100 forms part of a cellular telecommunications network, such as the type developed by the 3^{rd} Generation Partnership Project (3GPP). Those skilled in the art will appreciate that various components of the network 100 are omitted from FIG. 1 for the purposes of clarity.

The network 100 comprises at least one base station 102. In the illustrated embodiment, one base station 102 is shown, although the skilled person will appreciate that the network 100 may comprise any number of base stations, and may comprise many more base stations than the one shown. The base station 102 may be a NodeB, eNodeB, gNodeB or any other suitable network access point.

In the illustrated embodiment, the base station 102 is connected to a core network 106, e.g., via a backhaul network. The core network 106 comprises one or more core network nodes (not illustrated).

The network 100 further comprises a management node 108, which in the illustrated embodiment is communicatively coupled to the core network 106. In other embodiments, the management node 108 may form part of the core network 106. According to embodiments of the disclosure, the management node 108 is operative to monitor the network to identify hardware faults or performance issues, and to arrange maintenance and repairs to mitigate those faults issues. For example, the management node may be an Operations Support System (OSS) or a Network Operations Centre (NOC).

In existing methods for monitoring power supply unit (PSU) failures in wireless communication networks, a base station transmits an alert signal to a NOC when a

PSU in the base station fails. In response to receiving the alert signal, operators at the NOC schedule replacement or repair of the faulty PSU. However, alert signals arising from PSU failures can be a frequent occurrence in wireless communication networks, generating a considerable signalling overhead. In addition, base stations are often provided with multiple PSUs, creating a redundancy that allows a base station to continue operating in the event of a PSU failure. At present, operators at the NOC cannot distinguish between critical PSU failures (i.e. those that affect base station operations) and PSU failures that have little or no impact on base station operations. This can lead to prolonged service disruptions or outages at base stations experiencing a critical PSU failure, and/or unnecessary repairs at base stations experiencing a non-critical PSU failure.

Embodiments of the disclosure provide methods, apparatus and machine-readable mediums in which alert signals are provided to the management node 108 upon failure of a PSU, only if that failure adversely impacts performance of the base station. For example, one aspect provides a method in a network node in a wireless communication network 100. In response to determining that a PSU in a base station 102 has failed, the network node compares an available power of one or more remaining operational PSUs in the base station 102 with a predicted power usage of the base station 102 to determine a power headroom. The network node then determines whether to generate an alert signal based on the power headroom.

According to embodiments of the disclosure therefore, alert signals are generated and transmitted in the event of a PSU failure in a base station 102 if the power provided by the remaining operational PSUs is insufficient to power the base station 102. The frequency of power failure alert signals is therefore reduced, thereby reducing signalling in wireless communication networks and mitigating the problem of unnecessary repairs and maintenance.

The network node performing this method may be, for example, the base station 102 itself. Alternatively, the method may be performed by a computing server 104, which is communicatively coupled to the core network 106 and the base station 102 (e.g., in a cloud computing environment). In a further alternative, the method may be performed by the management node 108 itself. Embodiments of the disclosure thus provide a method for monitoring PSU failures in a wireless communications network 100, whilst reducing signalling in the network 100 and mitigating the problem of unnecessary repairs and maintenance.

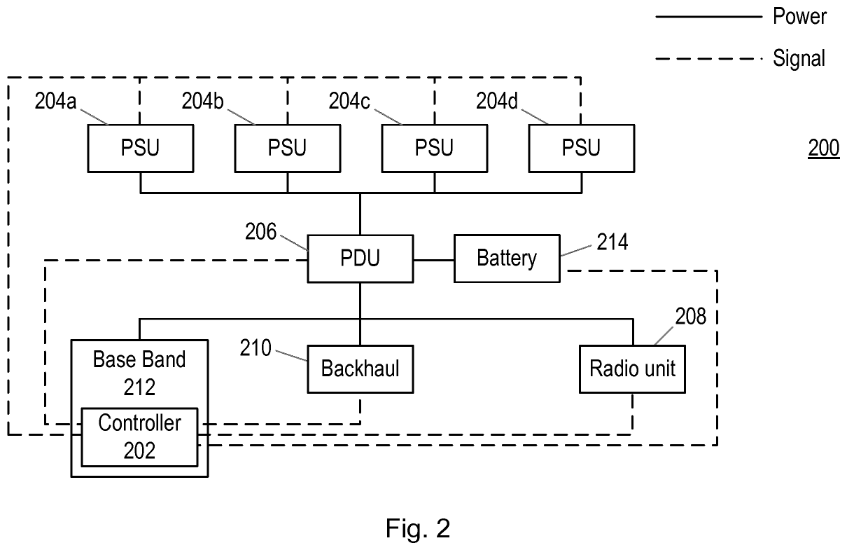

FIG. 2 is a schematic illustration of a base station 200 according to embodiments of the disclosure. The base station 200 may be, for example, the base station 102 described above with respect to FIG. 1.

The base station 200 comprises a controller 202 (which may comprise a function inside a baseband unit 212, as illustrated) communicatively coupled to receive signals and/or data from hardware units in the base station. It will be apparent to those skilled in the art that the base station 200 may comprise additional hardware that is not shown in FIG. 2.

As illustrated, the base station 200 comprises a number of hardware units: four PSUs 204a-204d (together 204), a power distribution unit (PDU) 206, a battery 214, a backhaul interface 210 and a radio unit 208. Solid lines illustrate a power connection between hardware units, whereas dashed lines illustrate a signal connection between hardware units.

The PSUs 204 provide power to the other hardware units in the base station 200. The PSUs 204 are connected to the PDU 206, which distributes the supplied power amongst the hardware units in the base station 200.

The PDU 206 is further connected to a battery 214, which provides a backup and/or booster power supply for the base station 200.

The radio unit 208 is configured to perform radio signal processing. The baseband unit 212 is configured to perform baseband signal processing. The backhaul interface 210 is configured to process backhaul signalling. For example, a backhaul interface may process signalling (e.g., electronic, microwave, optical signalling) between the base station and a backhaul network which connects the base station 200 to a core network (such as the core network 106).

FIG. 2 thus shows an example configuration of a base station to which embodiments of the disclosure may be applied. Those skilled in the art will appreciate that base stations may be configured differently, and/or have different hardware units to those illustrated. The present disclosure is not limited in that respect.

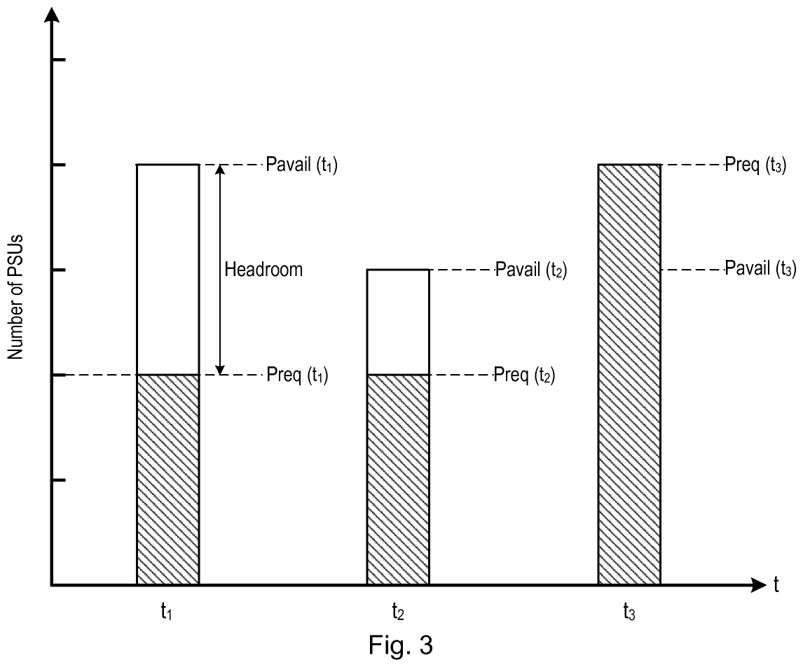

FIG. 3 shows variation in a power usage (or required power), Preq, and an available power, Pavail, of a base station in a wireless communication network over time t according to embodiments of the disclosure. The base station may, for example, be either of the base stations 102, 200. The vertical axis represents power or the number of operational PSUs. In the latter case, it is assumed that each PSU provides a similar amount of power, and thus the number of PSUs is an equivalent measure of power. Those skilled in the art will appreciate that in alternative embodiments the PSUs for a base station may provide different amounts of power.

As illustrated in FIG. 3, at time t₁ the operational PSUs at the base station 200 produce a total available power Pavail(t₁). The available power may be measured at the base station 200, or it may be an estimated available power. For example, the available power may be estimated based on a number of PSUs at the base station 200 that are operational.

The power usage Preq of the base station 200 may be an actual power usage measured at the base station 200 or a predicted power usage of the base station 200. At time t₁ the power usage of the base station 200, Preq(t₁), is less than the available power of the base station 200, such that there is a power headroom equal to Pavail(t₁)−Preq(t₁).

At a later time t₂, one of the PSUs at the base station 200 has failed, decreasing the available power of the base station 200 to Pavail(t₂)<Pavail(t₁). According to existing methods for managing PSU failures in a base station, the base station 200 would transmit an alarm to a NOC in response to the PSU failure. Operators at the NOC would then schedule a site visit to repair or replace the failed PSU. However, as illustrated by FIG. 3, the available power supplied by the remaining operational PSUs is still greater than the power usage Preq(t₂) of the base station 200. Thus, the base station 200 can continue to operate despite the PSU failure.

According embodiments of the disclosure, in response to the PSU failure in the base station 200, a network node first compares the available power Pavail(t₂) at the base station 200 with the power usage Preq(t₂) to determine the power headroom, Pavail(t₂)−Preq(t₂). The network node then determines whether to generate an alert signal based on the power headroom. In some embodiments, the network node determines to generate the alert if the power headroom is less than a threshold value. For example, the network node may generate an alarm if the power headroom is less than a safety margin. The safety margin may be, for example, an expected average power supplied by one power supply unit in the base station 200. In another example, the network node may generate an alarm if the power headroom is less than zero, such that the available power is less than the power usage. The network node may therefore generate an alarm if the power headroom is insufficient. Thus, in the situation illustrated in FIG. 3, the network node does not generate the alarm at time t₂, as the power headroom at time t₂ is greater than zero.

However, at a later time t₃ the power requirements of the base station 200 have increased, which may be a result of, for example, an increase in a volume of traffic handled by the base station 200. As illustrated, the power usage Preq(t₃) of the base station 200 at time t₃ is greater than the available power Pavail(t₃), which means that the power supplied by the remaining PSUs is insufficient to power the base station 200. The base station 200 may be provided with a battery to provide additional power to the base station 200 in the event of a power supply unit failure at the base station 200. However, this may only be a temporary measure to allow the base station 200 to function until the failed power supply unit can be repaired or replaced.

According to embodiments of the disclosure, after determining not to generate the alarm at time t₂, the network node continues to monitor the power headroom of the base station 200. The network node re-determines the available power and/or the power usage of the base station 200 in order to determine an updated power headroom. The network node then determines, based on the updated power headroom, whether to generate an alert signal. As described above, the network node may determine to generate the alert if the power headroom is less than a threshold value. The threshold value may be greater than zero. For example, the threshold value may be equal to an expected power output of a power supply unit so that the base station operates with at least one redundant power supply unit. In an alternative example, the threshold value may be zero, such that the network node generates an alarm if the available power is less than the power usage. Thus, in the situation illustrated in FIG. 3, the network node determines at time t₃ that the power headroom is less than zero (i.e. Pavail<Preq), and therefore generates an alert signal. The alert signal may then be transmitted to another network node in the wireless communication network.

Embodiments of the disclosure thus provide an improved method for monitoring power supplies in base stations in wireless communication networks.

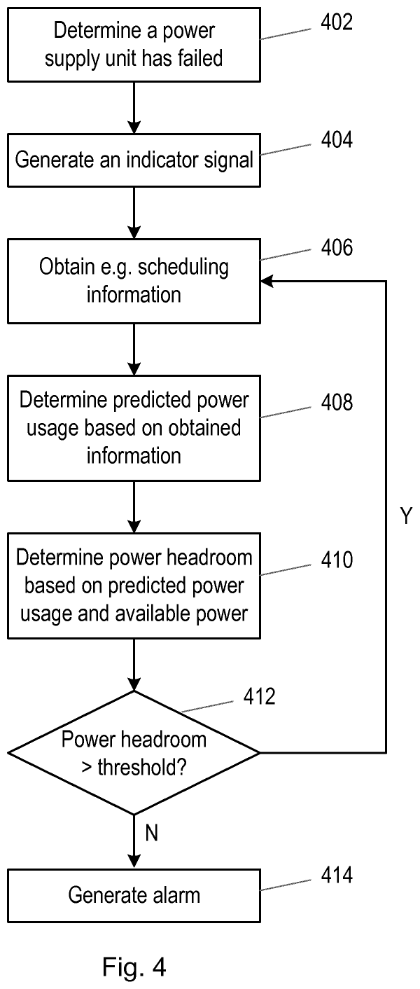

FIG. 4 is a flowchart of a method in a first network node in a wireless communication network according to embodiments of the disclosure. The wireless communication network may comprise the wireless communication network 100 illustrated in FIG. 1, for example. The first network node may be a base station (such as the base station 102 or the base station 200), or it may be any other network node in the wireless communication network 100. The first network node may be, for example, a management node (such as the management node 108 illustrated in FIG. 1) or a computing server (such as the computing server 104 illustrated in FIG. 1) communicatively coupled to the base station 102.

The method begins in step 402, in which the first network node determines that a PSU in a base station in the wireless communication network 100 has failed. The base station may be the first network node itself, as noted above.

In the latter case, in which the first network node is not the base station 102, the determination that the PSU in the base station 102 has failed may be based on signalling received at the first network node from the base station 102. For example, the first network node may receive a message from the base station 102 indicating that the PSU has failed. The message may be transmitted directly to the first network node or indirectly, via one or more intermediate network nodes.

In step 404, responsive to the determination in step 402, the first network node generates an indicator signal. The indicator signal comprises an indication that the PSU has failed. The indicator signal may further comprise an indication of a number of operational PSUs in the base station 102. If more than one power supply unit in the base station 102 fails, one consolidated indicator signal may be generated. Alternatively, multiple indicator signals may be generated. For example, one indicator signal may be generated per power supply unit failure.

The indicator signal may be used in different ways according to different embodiments of the disclosure. For example, in one embodiment, the first network node may transmit the indicator signal to a second network node in the wireless communication network 100, such as the management node 108. The first network node may transmit the indicator signal upon determining that the PSU has failed or, alternatively, the first network node may transmit the indicator signal to the second network node on request from the second network node. In either case, the second network node is notified of the PSU failure in the base station 102. In alternative embodiments, the indicator signal may be stored locally at the first network node, e.g., to provide information to service personnel on a subsequent maintenance visit.

The method then proceeds to step 406, in which the first network node obtains information indicative of a power usage of the base station 102. In an alternative embodiment, step 404 may be omitted and the method may proceed directly from step 402 to step 406. In which case, step 406 may be performed responsive to step 402. That is, the first network node may obtain information indicative of the power usage of the base station 102 in response to the determination that a PSU has failed. Alternatively, the first network node may continually monitor information indicative of the power usage of the base station 102, regardless of whether a PSU has failed.

The obtained information may comprise scheduling information for the base station 102. The scheduling information may include a number of transmissions scheduled for transmission by the base station 102, or an amount of radio resources on which transmissions are scheduled (e.g., time, transmission frequency, and/or coding resources). The scheduling information may comprise a transmission power for the scheduled transmissions. The transmission power may, for example, be a peak transmission power or an average transmission power of the scheduled transmissions.

Those skilled in the art will appreciate that the power usage of a base station varies as a function of the resources it uses for transmissions. For example, when the base station 102 is scheduled to transmit using a relatively large amount of resources at any one time (e.g. a relatively large number of frequencies), the power usage of that base station 102 will also be relatively high; when the base station 102 is scheduled to transmit using relatively few resources at any one time (e.g. a relatively low number of frequencies), the power usage of that base station 102 will be relatively low.

The obtained information may additionally or alternatively comprise historical radio traffic information for the base station 102. The historical radio traffic information may comprise a volume of traffic handled by the base station 102. The traffic volume may be an average traffic volume or a peak traffic volume measured over a period of time.

The historical radio traffic information may comprise a transmission power of historical transmissions made by the base station 102. The transmission power may, for example, be an average transmission power or a peak transmission power of transmissions made by the base station 102 over a period of time.

The obtained information may additionally or alternatively comprise historical power usage information for the base station 102. The historical power usage information may be an average power usage or a peak power usage of the base station 102 measured over a period of time. The historical power usage information may be indicative of a variation in the power usage of the base station 102. For example, the historical power usage information may comprise a time series indicating the variation of the power usage of the base station 102 with time, or a standard deviation of the power usage of the base station 102 measured over a period of time.

The obtained information may additionally or alternatively comprise a type of one or more hardware units in the base station 102 and/or a number of hardware units in the base station 102. For example, the obtained information comprises a number of antenna in the base station 102. In another example, the obtained information may comprise an indication of whether the base station 102 comprises any climate control apparatuses (e.g. fans).

The obtained information may additionally or alternatively comprise location information for the base station 102. The obtained information may thus, for example, comprise a latitude, longitude and/or altitude of the base station. Those skilled in the art will appreciate that the power usage of a base station may vary depending on the location of the base station. The location of a base station may be used as a proxy for other factors that influence the power consumption of a base station. For example, a base station in a location associated with extreme climate conditions (e.g. a desert), may be associated with a higher power usage due to the additional demands the local climate places on any climate control hardware in the base station 102. In another example, base stations located in densely populated areas may experience larger traffic volumes than those located in sparsely populated areas. As the power consumption of a base station may depend on the volume of traffic handled by the base station, the location of the base station may thus be indicative of the power usage of the base station.

The obtained information may additionally or alternatively comprise temperature information for the base station 102. The obtained information may thus, for example, comprise an operating temperature of the base station 102. The temperature information may be historical. For example, the obtained information may comprise a time series indicating a variation in temperature measurements at the base station 102 over time. The temperature information may comprise predicted temperature information. For example, the temperature information may comprise a forecast for expected operating temperatures of the base station 102 over a period of time.

The obtained information may additionally or alternatively comprise battery charging information for one or more batteries in the base station 102. As described above in relation to FIG. 2, a base station may comprise one or more batteries that provide a backup or booster power supply for the base station. Power from the remaining PSUs at the base station may be used to charge the one or more batteries at the base station. Therefore, battery charge information such as, for example, the remaining charge of the one or more batteries and/or the capacity of the one or more batteries, may be indicative of the power usage of the base station.

Those skilled in the art will appreciate that the obtained information may comprise any combination of the types of information described above. For example, the obtained information may comprise a volume of traffic handled by the base station over a particular time period, along with measurements of the power usage of the base station over that time period.

The method then proceeds to step 408 in which the first network node determines a predicted power usage based on the obtained information. The predicted power usage may be a predicted peak or average power usage for the base station 102 over a particular period of time. The period of time may be predetermined; for example, the predicted power usage may be an average power that the base station 102 is predicted to use in the month subsequent to the PSU failure. The period of time may be determined based on, for example, a maintenance schedule for the base station 102. The predicted power usage may thus be, for example, the maximum power that the base station 102 is predicted to use until the next scheduled site visit.

The predicted power usage is determined based on the obtained information. In one embodiment, the predicted power usage of the base station 102 may be equal to a historical power usage of the base station 102. For example, the predicted power usage of the base station 102 may be equal to a peak power usage of the base station 102 measured over a period of time. In an alternative example, the predicted power usage of the base station 102 may be equal to an average power usage of the base station 102 measured over a period of time.

In particular embodiments, the predicted power usage of the base station 102 is determined based on the obtained information using a predictive power usage model. The predictive power usage model may comprise a regression model. The predictive power usage model may be developed using a machine learning algorithm. Various different machine learning techniques may be used for the machine learning algorithm, including decision trees, random forests, neural networks, recurrent neural networks/long-short term memory etc. The present disclosure is not limited in that respect.

In step 410, the base station 102 determines a power headroom based on the predicted power usage and an available power of the one or more remaining operational PSUs in the base station 102. The power headroom may be the difference between the predicted power usage and the available power of the remaining PSUs at the base station 102 that are still operational.

The available power of the one or more remaining operational PSUs at the base station 102 may be measured, received via signalling or otherwise determined at the first network node. In some embodiments, the available power is a measured output power of the remaining PSUs at the base station 102 that are still operational. Thus, in embodiments in which the method is performed in the computing server 104, an output power of the one or more remaining operational PSUs at the base station 102 may be measured at the base station 102 and then transmitted to the computing server 104.

In other embodiments, the available power may be determined based on one or more of the following: a number of remaining operational PSUs in the base station 102, an expected power output of each remaining PSU, an operating temperature of the remaining operational PSUs, historical measurements of the available power at the base station 102, or any other suitable information. For example, the available output power may be determined based on the number of remaining operational PSUs in the base station and an expected power output of each remaining PSU. In another example, the available output power may be determined based on a historical measurement of an available power at the base station (prior to the PSU failure) and a fraction of PSUs at the base station that are still operational.

In step 412, the first network node compares the power headroom with a threshold value. If the power headroom is greater than the threshold value, the method returns to step 406, in which the first network node obtains information indicative of a power usage of the base station 102. The first network node may thus continue to monitor the power usage (and thus the power headroom) of the base station 102 to determine whether the power headroom drops below the threshold value.

The first network node may, additionally or alternatively, transmit the indicator signal generated in step 404 to the second network node in the wireless communication network in response to determining that the power headroom is greater than the threshold value.

In further embodiments, the method may end in response to the determination that the power headroom is greater than the threshold value. The first network node may monitor for further power supply unit failures in the base station 102. Thus, if the network node determines at a later point that another power supply unit in the base station 102 has failed, the method may restart from step 402.

If, in step 412, the first network node determines that the power headroom is less than the threshold value, the method proceeds to step 414. In step 414, the first network node generates an alert signal (e.g. an alarm). Thus the alert signal is only generated if the power headroom is less than the threshold value. It will be noted that the alert signal has a higher priority than the indicator signal discussed above with respect to step 404. For example, the alert signal may be associated with a requirement for immediate repair or replacement of the faulty PSU, whereas the indicator signal may not be associated with a requirement for such action.

The threshold value may be predetermined. The threshold value may be equal to zero, such that an alert signal is only generated when the output power of the remaining operational PSUs is less than the predicted power usage of the base station 102. In other embodiments, the threshold value is greater than zero, such that an alert signal is only generated when the output power of the remaining operational PSUs is less than the predicted power usage plus some safety margin. In the latter case, the threshold value may be set to account for any small fluctuations (within the safety margin) in the power usage of the base station 102.

Alternatively, the threshold value may be based on the available power of the one or more remaining PSUs. The threshold value may thus, for example, be a fraction of the available power of the one or more remaining PSUs. For example, the threshold value may be equal to 10% of the available power of the remaining PSUs, such the alert signal is generated if the predicted power usage is greater than 90% of the available power at the base station 102.

The method may further comprise transmitting the alert signal to a third network node in the wireless communication network 100. The third network node may be the second network node mentioned in relation to step 404. If the method is performed in the base station 102 itself (i.e. the first network node is the base station 102), the third network node may be, for example, the management node 108 or the computing server 104. Alternatively, if the method is performed in the computing server 104, the third network node may be, for example, the management node 108.

Therefore, in particular embodiments the first network node, on determining that a PSU in the base station 102 has failed, generates an indicator signal in step 404. The indicator signal may then be transmitted to a second network node. The first network node compares the power usage of the base station 102 with an available power of the remaining operational PSUs to determine a power headroom in step 410, and, if the power headroom is less than a threshold value, the first network node generates an alert signal. The alert signal may then be transmitted to the second network node. The alert signal may be associated with a higher priority than the indicator signal described in relation to step 404. The indicator signal may serve to notify the second network node that a PSU in the base station 102 has failed, whereas the transmission of the alert signal may indicate that repair and/or replacement of the faulty PSU may be necessary. The transmission of (or lack of transmission of) the alert signal may thus provide an indication of the severity of the PSU failure.

Although FIG. 4 provides a sequence in which the steps of embodiments of the disclosure may be performed, those skilled in the art will appreciate that other sequences are possible, and the disclosure is not limited to the precise order of steps set out in FIG. 4. In one particular embodiment, for example, the indicator signal is generated subsequent to the determination of the power headroom in step 410. In such embodiments, the indicator signal may further comprise an indication of the power headroom. For example, the indicator signal may be generated responsive to a determination in step 412 that the power headroom is greater than the power threshold.

The indicator signal may then be transmitted to the second network node in the wireless communication network 100.

Thus FIG. 4 sets out a method that allows reducing the frequency of alarms arising from PSU failures in base stations in wireless communication networks.

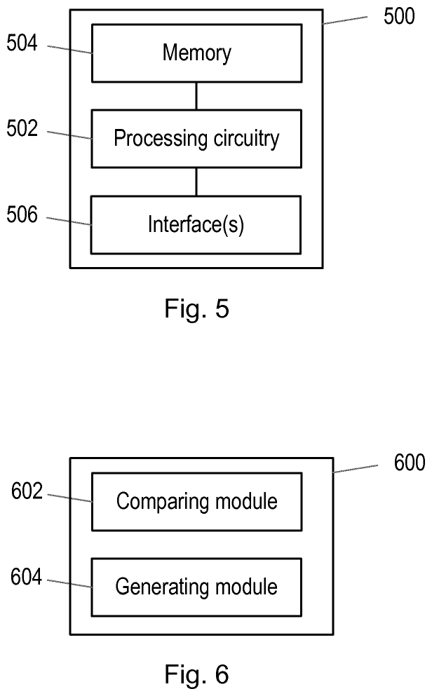

FIG. 5 is a schematic diagram of a network node 500 according to embodiments of the disclosure. The network node 500 may be configured to carry out the method described above with respect to FIG. 4, for example.

The network node 500 comprises processing circuitry 502 and a machine-readable medium (such as memory) 504. The machine-readable medium 504 stores instructions which, when executed by the processing circuitry 502, cause the network node 500 to: responsive to a determination that a PSU in a base station in the wireless communication network has failed, compare an available power of one or more remaining operational PSUs in the base station with a predicted power usage of the base station to determine a power headroom. The network node 500 is further caused to determine whether to generate an alert signal based on the power headroom.

In the illustrated embodiment, the network node 500 also comprises one or more interfaces 506, for receiving signals from other nodes of the network and/or transmitting signals to other nodes of the network. The interfaces 506 may use any appropriate communication technology, such as electronic signalling, optical signalling or wireless (radio) signalling.

In the illustrated embodiment, the processing circuitry 502, the machine-readable medium 504 and the interfaces 506 are operatively coupled to each other in series. In other embodiments, these components may be coupled to each other in a different fashion, either directly or indirectly. For example, the components may be coupled to each other via a system bus or other communication line.

FIG. 6 is a schematic diagram of a network node 600 according to embodiments of the disclosure. The network node 600 may be configured to carry out the method described above with respect to FIG. 4, for example.

The network node 600 comprises a comparing module 602. The comparing module 602 is configured to: responsive to a determination that a PSU in a base station in the wireless communication network has failed, compare an available power of one or more remaining operational PSUs in the base station with a predicted power usage of the base station to determine a power headroom.

As illustrated, the network node 600 further comprises a generating module 604. The generating module 604 is configured to determine whether to generate an alert signal based on the power headroom.

The network node 600 may also comprise one or more interface modules (not illustrated), for receiving signals from other nodes of the network and/or transmitting signals to other nodes of the network. The interfaces may use any appropriate communication technology, such as electronic signalling, optical signalling or wireless (radio) signalling.

The modules described above with respect to FIG. 6 may comprise any combination of hardware and/or software. For example, in an embodiment, the modules are implemented entirely in hardware. As noted above, hardware implementation may include or encompass, without limitation, digital signal processor (DSP) hardware, a reduced instruction set processor, hardware (e.g., digital or analog) circuitry including but not limited to application specific integrated circuit(s) (ASIC) and/or field programmable gate array(s) (FPGA(s)), and (where appropriate) state machines capable of performing such functions. In another embodiment, the modules may be implemented entirely in software. In yet further embodiments, the modules may be implemented in combinations of hardware and software.

The present disclosure therefore provides methods, apparatus and machine-readable mediums for reducing signalling in wireless communication networks by reducing the frequency of power failure alarms. Specifically, the present disclosure provides methods, apparatus and machine-readable mediums that allow for transmitting an alarm in the event of a PSU failure in a base station only if the remaining PSUs still in operation at the base station are unable to provide the base station with a sufficient supply of power.

It should be noted that the above-mentioned embodiments illustrate rather than limit the concepts disclosed herein, and that those skilled in the art will be able to design many alternative embodiments without departing from the scope of the appended following claims. The word “comprising” does not exclude the presence of elements or steps other than those listed in a statement, “a” or “an” does not exclude a plurality, and a single processor or other unit may fulfil the functions of several units recited in the statements. Any reference signs in the claims shall not be construed so as to limit their scope.

1-21. (canceled)

22. A method performed by a first network node in a wireless communication network, the method comprising:
responsive to a determination that a power supply unit in a base station in the wireless communication network has failed, comparing an available power of one or more remaining operational power supply units in the base station with a predicted power usage of the base station to determine a power headroom; and
determining whether to generate an alert signal based on the power headroom.

23. The method of claim 22, further comprising:
responsive to a determination that the power headroom is less than a threshold value, generating the alert signal.

24. The method of claim 22, further comprising:
transmitting the alert signal to a second network node in the wireless communication network.

25. The method of claim 22, wherein the predicted power usage of the base station is determined based on one or more of:
scheduling information for the base station;
historical radio traffic information for the base station;
historical power usage information for the base station;
a type of one or more hardware units in the base station;
a number of hardware units in the base station;
a location of the base station; and
temperature information for the base station.

26. The method of claim 22, wherein the predicted power usage is determined using a predictive model developed using a machine learning algorithm.

27. The method of claim 22, further comprising:
responsive to a determination that a power supply unit in a base station in the wireless communication network has failed, generating an indicator signal comprising an indication of the failed power supply unit, wherein the indicator signal is associated with a lower priority than the alert signal.

28. The method of claim 27, wherein the indicator signal further comprises an indication of one or more of the following:
the power headroom; and
a number of remaining operational power supply units in the base station.

29. The method of claim 27, further comprising:
transmitting the indicator signal to a third network node in the wireless communication network.

30. The method of claim 29, wherein the step of transmitting the indicator signal is responsive to receiving a request from the third network node.

31. The method of claim 22, wherein the first network node is one of: the base station; a computing server coupled to the base station; and a core network node in the wireless communication network.

32. A network node in a wireless communication network, the network node comprising processing circuitry and a machine-readable medium storing instructions that, when executed by the processing circuitry, cause the network node to:
responsive to a determination that a power supply unit in a base station in the wireless communication network has failed, compare an available power of one or more remaining operational power supply units in the base station with a predicted power usage of the base station to determine a power headroom; and
determine whether to generate an alert signal based on the power headroom.

33. The network node of claim 32, wherein the instructions are further configured to cause the network node to:
responsive to a determination that the power headroom is less than a threshold value, generate the alert signal.

34. The network node of claim 32, wherein the instructions are further configured to cause the network node to:
transmit the alert signal to a second network node in the wireless communication network.

35. The network node of claim 32, wherein the instructions are configured to cause the network node to determine the predicted power usage of the base station based on one or more of:
scheduling information for the base station;
historical radio traffic information for the base station;
historical power usage information for the base station;
a type of one or more hardware units in the base station;
a number of hardware units in the base station;
a location of the base station; and
temperature information for the base station.

36. The network node of claim 32, wherein the instructions are configured to cause the network node to determine the predicted power usage using a predictive model developed using a machine learning algorithm.

37. The network node of claim 32, wherein the instructions are further configured to cause the network node to:
responsive to a determination that a power supply unit in a base station in the wireless communication network has failed, generate an indicator signal comprising an indication of the failed power supply unit, wherein the indicator signal is associated with a lower priority than the alert signal.

38. The network node of claim 37, wherein the indicator signal further comprises an indication of one or more of the following:
the power headroom; and
a number of remaining operational power supply units in the base station.

39. The network node of claim 37, wherein the instructions are further configured to cause the network node to:
transmit the indicator signal to a third network node in the wireless communication network.

40. The network node of claim 32, wherein the first network node is one of: the base station; a computing server coupled to the base station; and a core network node in the wireless communication network.

41. A non-transitory machine-readable medium storing instructions that, when executed by processing circuitry of a network node, cause the network node to:
responsive to a determination that a power supply unit in a base station has failed, compare an available power of one or more remaining operational power supply units in the base station with a predicted power usage of the base station to determine a power headroom; and
determine whether to generate an alert signal based on the power headroom.
